(19) United States
(12) Patent Application Publication
(10) Pub. No.: US 2005/0259523 A1
(43) Pub. Date: Nov. 24, 2005

(54) Car front seat head rest mountable DVD/LCD module with vertical disc insert

(76) Inventor: Cheol Ho Kang, Seoul (KR)

Correspondence Address: Eugene Oak, Ph.D., J.D., Patent Attorney, 610 S. Van Ness Ave., Los Angeles, CA, 90005, US

(21) Appl. No.: 10/849,177

(22) Filed: May 20, 2004

(51) Int. Cl. G11B 5/09; H04N 5/781

(52) U.S. Cl. 369/2; 369/6; 369/47.1; 386/125

(57) ABSTRACT

A portable DVD (Digital Video Disc) player combined with an LCD (Liquid Crystal Displayer) is provided. In current application the DVD and LCD are combined in one module. In the module of the current application the screen of the LCD faces outward and the DVD loader is placed behind the LCD. An opening cleavage is developed on the upper surface of the DVD player. Just below the opening cleavage is located a DVD loader inside of the DVD module. The DVD/LCD module is mounted at the back side of a head rest of a front seat of a car with the aid of a supporting frame connecting the head rest pole and the DVD/LCD module.

### FIELD OF THE INVENTION

This invention related a portable DVD/LCD player mountable on the rear face of a front car seat's head rest.

### BACKGROUND OF THE INVENTION

Some of the DVD players for a car of these days are installed on a driver's control box sharing the screen with navigation systems. However, visual amusement system installed on the driver's control box may cause critical danger for a safe driving. Meanwhile, more people want to have a car with visual amusement system installed inside. To meet such requirement, most of the new car have a with DVD player installed inside of the ceiling of the car facing the passengers at the back row seat. Those DVD players have separate screen and control box for DVD insert. They require a passenger to open the DVD box hidden in the ceiling, open the DVD track, insert a DVD, close the track, and adjust the screen. It is difficult for a children or senior person, who used to be the passengers sit on the back row seat. Moreover, the LCD monitor stretched from the ceiling may block the sight of a driver's indoor back mirror. The DVD player of the current application eliminates those inconveniences for a safe driving.

### DESCRIPTION OF THE PRIOR ART

U.S. Patent Application 20030128183 to Chang illustrates an overhead monitor in combination with a DVD player includes a fixed plate adapted to be mounted in a ceiling of an automobile and provided with a concave area and a recessed area defined in a bottom face defining the concave area to receive therein the DVD player and a moving plate pivotally connected to the fixed plate and having the monitor embedded therein. The DVD player has a cover with a wedge and an extension, a clamp and a hole with a sensor received therein are defined in a face of the concave area to respectively correspond to the wedge and the extension, so that only when the cover securely engages the face of the concave area, can the DVD player be operated normally.

U.S. Patent Application 20010007609, U.S. Pat. No. 6,374,040, and U.S. Pat. No. 6,169,847 to Mizoguchi, et al. illustrates a built-in components in the portable-type apparatus each operate on power from the power supply (PS) unit having a built-in battery. The video data decoded by the video decoder (MPEG-DEC) and the sub-picture data decoded by the sub-picture decoder (Sub-Picture-DEC) are mixed with the video mixer (MIX) and then output to a display unit (DISP). An audio signal decoded by the audio decoder (Audio-DEC) is output from the speaker (SP). Those DVD are a “Note Book” computer type DVD player.

U.S. Pat. No. 6,724,317 to Kitano, et al. illustrates a visual-sound- reproducing system includes a display panel mounted on a ceiling of a cabin to reproduce a picture on a monitor screen. U.S. Pat. No. 6,304,173 to Pala, et al. illustrates a vehicle display system includes a display which is selectively movable between a first position a second position. In the first position, the display provides a rear view from a camera mounted at the rear of the vehicle. In the second position, the display provides entertainment to the passengers in the rear seats. U.S. Pat. No. 6,292,236, U.S. Pat. No. 6,246,449, and U.S. Pat. No. 5,946,055 to Rosen illustrate a ceiling-mounted automotive display unit mounted in the ceiling of an automobile above the front passenger seat. When the screen is deployed, the viewing surface typically is at an angle of between approximately 45- and 90-degrees from horizontal, promoting view ability of the screen. U.S. Pat. No. 5,927,784 to Vitito illustrates an overhead console for a motor vehicle, boat, or aircraft, is disclosed. The console includes a console housing having a leading end and a trailing end, a monitor mounted in the leading end of the console housing, and a compartment for storing a source of video signals.

U.S. Pat. No. 5,822,023 to Suman, et al. illustrates a projection system for projecting television images in a vehicle including a console for mounting to the roof of a vehicle with a housing in which a video projector 20 for television signals is fixedly mounted.

None of the prior arts illustrates a DVD/LCD one body module mountable on the rear side of a headrest of a front seat of a car.

### SUMMARY OF THE INVENTION

It is a purpose of the current application to provide an easy to use and easy to install, portable, DVD/LCD player module for a car. For that purpose a portable DVD (Digital Video Disc) player combined with an LCD (Liquid Crystal Displayer) is provided. In current application the DVD and LCD are combined in one module. In the module of the current application, the screen of the LCD faces outward and the DVD loader is placed behind the LCD. Switches for controlling the DVD player are located on the bottom of the front face of the LCD. Two speakers are attached on both of the front face of the LCD. An opening cleavage is provided on the upper surface of the DVD player. Just below the opening cleavage is located a DVD loader inside of the DVD module. Ports for cable connectors are provided on the lower parts of the two side surface of the DVD module. The ports are provided for external power, external audios in and out, and external videos in and out. Operation of the DVD/LCD module of the current application is so simple. Insert a DVD in to the insert cleavage, push the play switch, and enjoy. Turn off is just push the eject switch. No step of open the DVD control box and open the LCD module for the previous art are necessary. The DVD/LCD module of the current application is mounted at the back side of a head rest of a front seat of a car with the aid of a supporting frame connecting the head rest pole and the DVD/LCD module. Therefore, nothing blocks the driver's indoor back mirror for watching the rear side of the car.

### BRIEF DESCRIPTION OF THE DRAWINGS

FIG. 1 is a perspective view of the DVD/LCD module of the current application.

FIG. 2 is an over view of the DVD/LCD module of the current application showing the opening cleavage for a DVD insertion.

FIG. 3 is a bottom view of the DVD/LCD module of the current application showing the groove for installing connector to the poles of the head rest of the front seat.

FIG. 4 is a left side view from the front of the DVD/LCD module of the current application showing service port for audio and video out jacks.

FIG. 5 is a side right view from the front of the DVD/LCD module of the current application showing service port for audio and video in jacks.

FIG. 6 is an exploded perspective view of the DVD/LCD module of the current application.

FIG. 7 is an exploded perspective view of the LCD module portion of the current application.

FIG. 8 is an exploded perspective view of the DVD module portion of the current application.

FIG. 9 is a schematic diagram showing the installation of the DVD/LCD module of the current application to the back face of the head rest of the front seat of a car.

FIG. 10 is a schematic diagram showing the operation of the DVD/LCD module of the current application.

### DETAILED DESCRIPTION OF THE PREFERRED EMBODINENMT

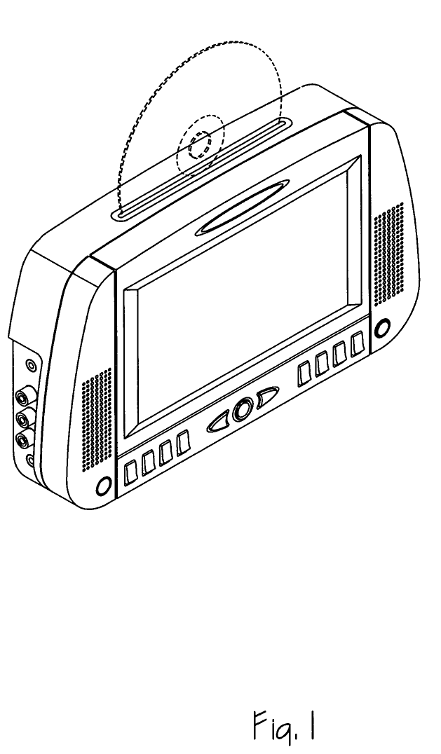

FIG. 1 is a perspective view of the DVD/LCD module (1) of the current application. In the module (1), a DVD loader (2) and an LCD monitor (3) are assembled in one body. Switches (4) for controlling the DVD player (2) and the LCD monitor (3) are located on the bottom of the front face of the module (1). Two speakers (5) are mounted on the two sides of the front face of the module (1). The LCD monitor (3) locates at the center of the front face of the module (1).

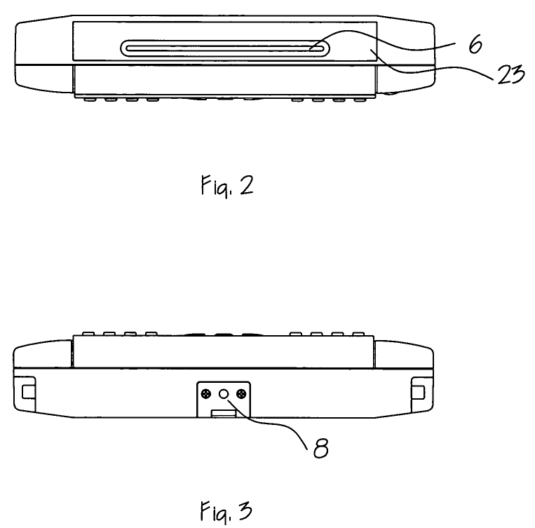

FIG. 2 is an over view of the DVD/LCD module (1) of the current application showing the opening cleavage (6) for a DVD insertion. An opening cleavage (6) for a DVD (7) insertion is developed at the center of the upper face of the DVD frame (23). FIG. 3 is a bottom view of the DVD/LCD module (1) of the current application showing the groove (8) for installing connector to the poles of the head rest of the front seat. A groove (8) for a connector is developed from the bottom to the middle of the rear face of the module (1).

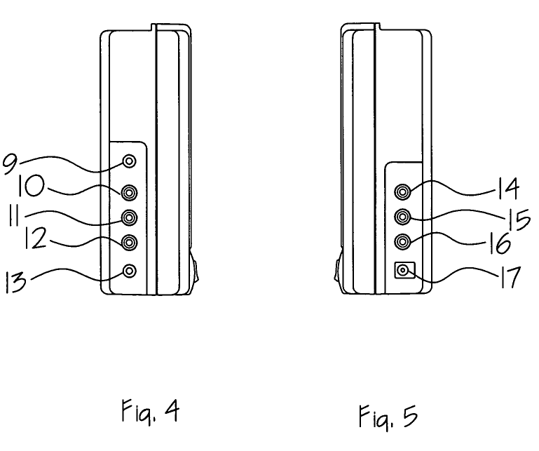

FIG. 4 is a left side view from the front of the DVD/LCD module (1) of the current application showing service port for audio and video out jacks. The service port (9) is for audio out jack to connect to the audio system of the car. The service port (10) and (11) are for video out jack and the service port (12) is for audio out jack for connection to the other DVD player system or Television monitor system. The service port (13) is for head phone jack. FIG. 5 is a right side view from the front of the DVD/LCD module of the current application showing service port for audio and video in jacks. The service port (14) is for an audio in jack and the service ports (15) and (16) are for video in jacks from other media sources. The service port (17) is for 12 Volt/DC input jack.

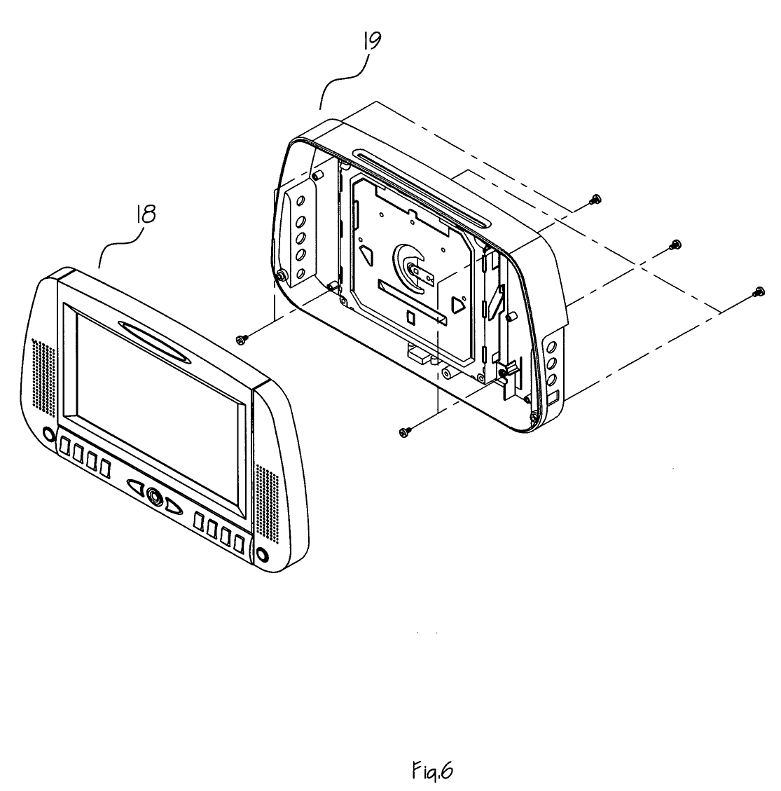

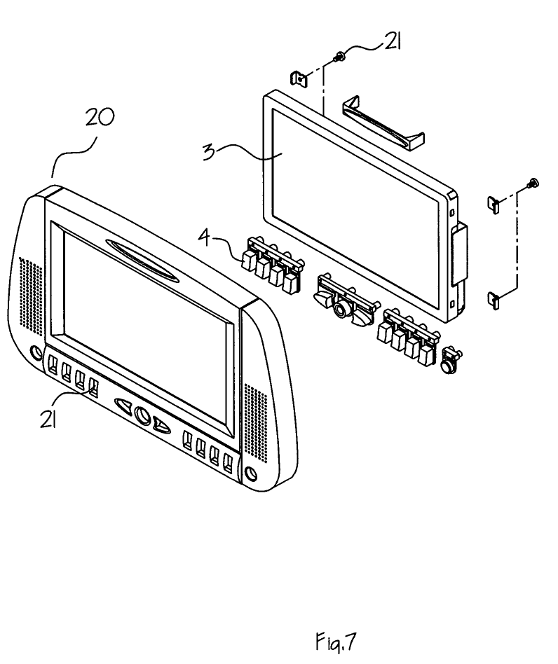

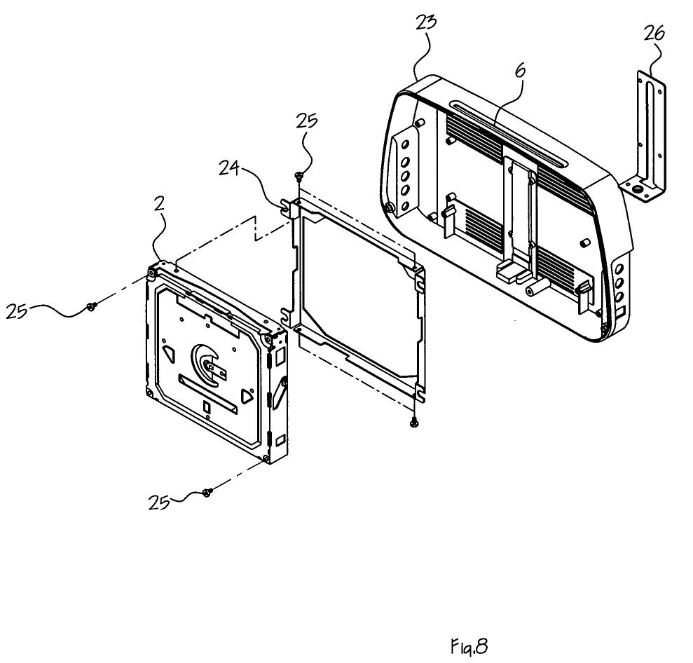

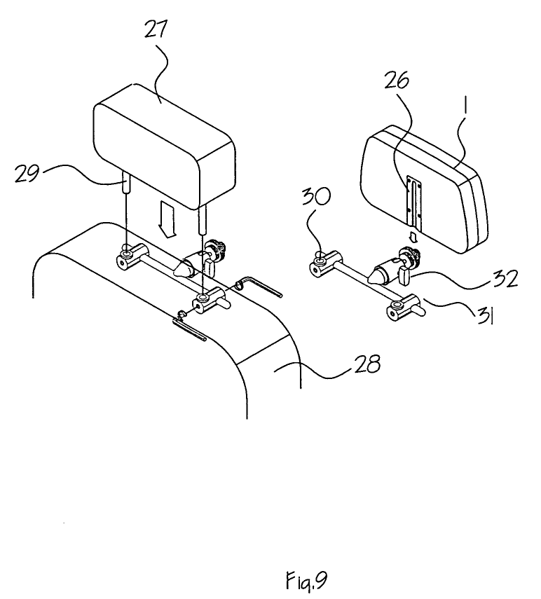

FIG. 6 is an exploded perspective view of the DVD/LCD module (1) of the current application. The module (1) of the current application is a combined assembly of the LCD module (18) and DVD module (19). FIG. 7 is an exploded perspective view of the LCD module (18) portion of the current application. An LCD monitor (3) is fixed to a monitor frame (20) with four screw bolts (21). Switches (4) for controlling the LCD monitor (3) and the DVD player (2) are fixed to the inside of the bottom of the monitor frame (2) to fit through the windows (22) developed thereon. FIG. 8 is an exploded perspective view of the DVD module portion (19) of the current application. A DVD loader (2) is fixed to a DVD frame (23) with a metal support frame (24) and eight screw bolts (25). An opening cleavage (6) for a DVD insertion is developed at the front center of the upper face (7) of the DVD frame (23). A groove (8) for a connector (26) is developed from the bottom to the middle of the rear face of the DVD frame (23).

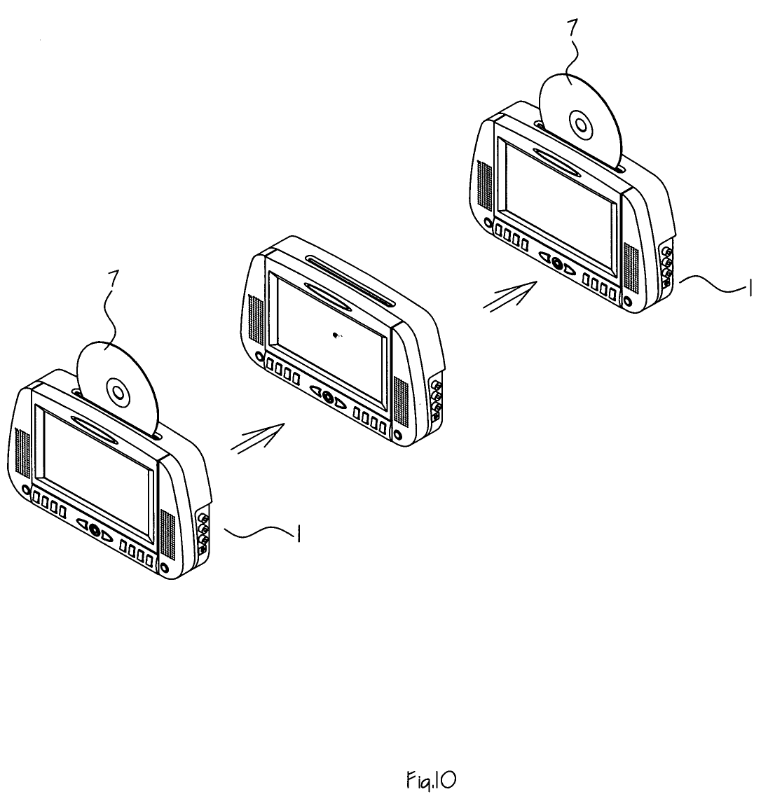

FIG. 9 is a schematic diagram showing the installation of the DVD/LCD module (1) of the current application to the back face of the head rest of the front seat of a car. Take out the head rest (27) from the front seat (28). Insert the two metal poles (29) for the head rest (27) of the front seat (28) into the holes (30) of the metal support frame (31). Engage the projected part (32) from the support frame (31) to the connector (26) fixed to the DVD/LCD module (1). Then push the head rest (27) onto the metal poles (29) and fasten the head rest (27) to the front seat (28).

FIG. 10 is a schematic diagram showing the operation of the DVD/LCD module (1) of the current application. Insert a DVD (7) into the module (1) through the opening cleavage (6) and then just press “play” button. After finish a movie, press “eject” button and power off.

The DVD/LCD module of the current application is easy to operate and easy to install to a car which was not designed for a DVD player inside of the car. Moreover, the screen of the LCD of the current application does not block the sight of rear view projected to the indoor back mirror located above the driver seat.

1. A portable DVD (Digital Video Disc) player combined with an LCD (Liquid Crystal Displayer) monitor in one module, wherein the screen of the LCD faces outward and an opening cleavage is developed on the upper surface of the DVD module for inserting a DVD to the loader which is placed behind the LCD and just below the opening cleavage.

2. The DVD/LCD module in claim 1, wherein the module is mounted at the backside of a headrest of a front seat of a car with the aid of a supporting frame connecting the head rest poles and the DVD/LCD module.

3. The DVD/LCD module in claim 1, wherein a DVD is inserted vertically into the loader from above of the module.
